(19) United States
(12) Patent Application Publication
(10) Pub. No.: US 2013/0044111 A1
(43) Pub. Date: Feb. 21, 2013

(54) User Configurable Central Monitoring Station

(71) Applicants: James VanGilder, Issaquah, WA (US); Robert Steurer, Sammamish, WA (US); William Gregory Downs, Snoqualmie, WA (US); Patricia Ruth Walters, Issaquah, WA (US)

(72) Inventors: James VanGilder, Issaquah, WA (US); Robert Steurer, Sammamish, WA (US); William Gregory Downs, Snoqualmie, WA (US); Patricia Ruth Walters, Issaquah, WA (US)

(21) Appl. No.: 13/472,332

(22) Filed: May 15, 2012

Related U.S. Application Data
(60) Provisional application No. 61/486,307, filed on May 15, 2011.

(51) Int. Cl. G06T 11/20

(52) U.S. Cl. 345/440

(57) ABSTRACT

The invention provides a dynamic central monitoring station having multiple touch screens for displaying numerical and graphical representation of vital statistics of one or more patients. The central monitoring station is connected to one or more bedside monitors and telemetry devices. The multiple touch screens are configurable to simultaneously display real time and historic patient data corresponding to a plurality of patients. One screen serves as a dedicated display screen for the review of individual patient data while the remaining screens continue to display vital statistics for all of the monitored patients.

### CROSS-REFERENCE TO RELATED APPLICATIONS

The present specification claims priority from U.S. Provisional Patent Application No. 61/486,307, entitled “User Configurable Central Monitoring Station”, filed on May 15, 2011 and herein incorporated by reference in its entirety.

### FIELD

This invention relates generally to patient monitoring systems. More particularly, the present invention relates to a system for patient monitoring using a dynamic central monitoring station that includes multiple touch screens in which the information displayed is user-configurable.

### BACKGROUND

A patient monitoring system is an electronic medical device that measures a patient's various vital signs, collects all measurements as data, and then displays said data graphically and/or numerically on a viewing screen. Graphical data is displayed continuously as data channels on a time axis. Current patient monitoring systems are able to measure and display a variety of vital signs, including, pulse oximetry (SpO₂), electrocardiograph (ECG), invasive blood pressure (IBP), non-invasive blood pressure (NIBP), electroencephalograph (EEG), body temperature, cardiac output, capnography (CO₂), and respiration. Patient monitoring systems are also capable of measuring and displaying maximum, minimum, and average values and frequencies, such as pulse and respiratory rates. In addition, patient monitoring systems are typically equipped with audio and visual alarms to notify medical personnel of changes in the patient's status. The alarm parameters can be set by the medical personnel.

Patient monitoring systems are positioned near hospital beds, typically in critical care units, where they continually monitor patient status and can be viewed by hospital personnel. Information gathered by patient monitoring systems is displayed locally by the bedside and, through the use of a wired or wireless network, is also often displayed remotely at a central monitoring station. The central monitoring station is a centrally located caregiver work area, typically within an intensive or critical care unit, which includes, but is not limited to, display screens, work stations, patient charts, and some medications. While not attending to individual patients, nursing personnel situate themselves at the central monitoring station where they can monitor the status of a multitude of patients simultaneously via the display screens.

While the display configurations of current central monitoring stations are effective in displaying patient vital signs and notifying medical personnel of changes, they are not without certain drawbacks. For example, most current central monitoring stations are limited in scale in the number of patients for which vital statistics can be displayed. For instance, most current systems are capable of displaying information for a maximum of 16 patients. This number might be sufficient for some critical care units, but would not be enough for larger critical care units or for possible use in non-critical units in which the number of inpatients monitored by a single station is greater. Therefore, a need exists for a central monitoring station with the capacity to display individual information for a larger group of patients simultaneously.

Display screens included with current central monitoring stations typically enable the user to open additional windows to obtain further information on a patient and to access programmable settings menus. However, these new windows usually open on top of the vital statistics being displayed, obscuring the real time information. What is needed is a central monitoring station that includes an additional, dedicated display. This dedicated display would act as a workstation and would be responsible for presenting information for a single patient or for manipulation of user defined settings.

In order to access and change settings, such as waveform amplitude and alarm thresholds, users of current central monitoring stations must access a separate window for each individual physiological parameter being measured and displayed. The user spends additional time accessing each individual parameter and can become confused by dissimilar interfaces of the various parameters, both leading to decreased efficiency. Therefore, what is needed is a central monitoring station that provides the user quick navigation to an interface in which he can access settings for all measured parameters from one consistent screen view.

While current central monitoring stations afford the user some degree of flexibility regarding what information is to be displayed, health care personnel would benefit from a greater level of customization. For example, a nurse might want to focus on a select group of patients that will require more attention due to the severity of their respective conditions. Therefore, what is needed is a central monitoring station in which the available space on the display screens can be configured by the user based on patient acuity. Monitoring personnel might also wish to view real time vital statistics for only more critical patients while data from more stable patients can be omitted from the display screens. However, the health care provider will still want to be notified of an alarm condition occurring for a patient whose information is not presented at the central monitoring station, beyond the audible alarm sounding at the patient's bedside. Therefore, what is also needed is a central monitoring station that includes audible and visual alarms for patients for whom the display of continuous real time vital statistics is unnecessary.

In addition, current central alarm stations typically only notify health care personnel of active alarm conditions. If the care provider wishes to examine trends over time regarding alarm activity for a specific patient, such as alarm frequency and type, he must access additional windows to obtain such history. This again obscures portions of the display screens and requires additional time to search for and analyze the historical data. Therefore, what is needed is a central monitoring station that provides the user a display of alarm activity for each patient over a certain time period and also indicates the type, severity, and duration of each alarm.

Critical care environments can often have fast paced periods of time in which hospital personnel are attending to the needs of several critical patients all at once. Oftentimes, caregivers will need to write notes to remind themselves or inform others of something regarding the patients' care. For example, a caregiver might write that a patient is in surgery, has a consult in the afternoon, or the time when a medication was last administered. Typically, these notes are handwritten on sticky notes which are then placed all about the central monitoring station, tending to clutter the observation area. Therefore, what is needed is a central monitoring station that provides a more permanent record of quick notes and does so in a cleaner manner.

### SUMMARY

The present specification is directed toward a dynamic patient monitoring system comprising: a central monitoring station coupled with a plurality of monitors to generate monitored physiological data dynamic central monitoring station comprising multiple touch screens for displaying numerical and graphical representation of vital statistics of one or more patients, the multiple touch screens being configurable to simultaneously display real time and historic patient data corresponding to a plurality of patients, wherein one of said multiple touch screens is reserved as a dedicated display for additional data review while the remaining screens continue to display data for all monitored patients.

In one embodiment, the touch screens display data corresponding to a plurality of patients in a plurality of zones, each patient being allocated one zone, each of the display zones having a size associated therewith, and wherein, when data from a new patient is acquired by the monitoring system, the sizes of the patient display zones automatically decrease by an amount sufficient to display the data from the new patient, provided that decreasing the sizes of the patient display zones does not result in any one patient display zone having a size less than a predefined number of pixels. In one embodiment, the sizes of all of the patient display zones are equal. In another embodiment, the sizes of all of said patient display zones are not equal. In one embodiment, the predefined number of pixels is in a range of 50 to 80 pixels. In one embodiment, the screens are configurable for removing a patient zone if a patient bed representing the zone is not in use, thereby increasing areas of the remaining of the plurality of zones for displaying additional patient data, further wherein a removed zone is restored when a new patient is admitted to the associated patient bed. In one embodiment, each patient zone is dynamically scalable with respect to each other patient zone to allow for the display of additional information for the associated patient.

In one embodiment, the central monitoring station is configurable to display up to 24 hours of patient data from within a 72 hour period at one time.

In one embodiment, the touch screen display comprises at least one icon which, when actuated for a first patient display zone associated with a first patient, causes the system to automatically display data corresponding to data that was displayed for the first patient within two minutes before the patient's most recent significant physiological event, during the patient's most recent significant physiological event, and within two minutes after the patient's most recent significant physiological event. In one embodiment, the significant physiological event includes an abnormal reading of the patient's SpO₂ level, ECG, invasive blood pressure, heart rate, non-invasive blood pressure, EEG, body temperature, cardiac output, CO₂ level, or respiration rates.

In one embodiment, the touch screens include a replay function that allows a user to review the dynamic data presentation corresponding to a patient as was seen on a bedside display just before a physiological change (pre-event), during the physiological change (the event), and after the patient has stabilized (post-event).

In one embodiment, the touch screens display an alarm watch zone for displaying alarm status corresponding to a set of predefined patients, wherein the display of vital statistics for said predefined patients is suppressed. In one embodiment, the predefined patients are predefined as less critical patients, wherein the touch screens display data corresponding to less critical patients when a predefined indication is displayed in the alarm watch zone corresponding to the patient, the touch screens being configurable to inhibit continuous display of vital signs of the less critical patients.

In one embodiment, the touch screens display an alarm bar associated with each patient for providing a graphical representation of an alarm history of each patient, the alarm bar being color coded to represent severity of an alarm by using a plurality of predefined colors. In one embodiment, the alarm bar provides a graphical representation of alarm history of each patient for the previous 30 minutes.

In one embodiment, the touch screens display a quick navigation function for allowing users access to one or more system settings menus of the central monitoring station without having to close the current menu and selecting a different menu. In one embodiment, the quick navigation function comprises a plurality of physiological parameter icons for accessing a consistent parameter submenu window comprising a plurality of tabs, each tab corresponding to a specific configurable medical parameter, the quick navigation function providing a graphical representation of parameter values over a predetermined period of time for assisting a user in setting maximum and minimum threshold values for alarm notification.

In one embodiment, the touch screens provide a direct connection to a clinical access suite for retrospective patient data review by a user.

In another embodiment, the touch screens display one or more electronic sticky notes for recording information corresponding to each patient, the touch screens displaying a sticky note icon beside each patient name, each sticky note icon upon being clicked displaying a window for entering, viewing and editing information regarding a corresponding patient.

In yet another embodiment, the touch screens display a cardiac view for representing cardiac data obtained from a pacemaker coupled with the central monitoring station enabling a user to visualize the pacemaker performance.

In another embodiment, the touch screens display a cardiac view for displaying a representation of ST values from one or more predefined cardiac monitor lead combinations.

In a further embodiment, the touch screens display is dynamically configurable based upon a patient acuity parameter computed by the central monitoring station by using a predefined set of rules.

In another embodiment, the touch screens display a Global Ischemic Index (GII) trend representing ST segment levels for three orthogonal leads of a cardiac machine connected to a patient's heart, the GII trend indicating ischemia in any portion of the heart.

The present specification is also directed toward a display station comprising: a first region for displaying a plurality of patient data wherein said patient data is associated with a first plurality of patients; and a second region for displaying a plurality of patient data wherein said patient data is associated with a second plurality of patients, wherein vital signs for said first plurality of patients are continuously displayed while vital signs for said second plurality of patients are not displayed and wherein vital signs for a patient from said second plurality of patients is only displayed when an alarm state is activated for said patient from said second plurality of patients.

The present specification is also directed toward a display station comprising: a first region for displaying a plurality of patient data wherein said patient data is associated with a plurality of patients; and a color coded graphical representation of an alarm history for each of said plurality of patients, wherein said color coded graphical representation of an alarm history displays a frequency, duration, or type of alarm condition experienced by each patient of said plurality of patients.

The present specification is also directed toward a dynamic patient monitoring system comprising: a central monitoring station coupled with a plurality of monitors to generate monitored physiological data; and a touch screen display adapted to receive and display numerical and graphical representations of monitored physiological data from a plurality of patients, wherein the touch screen display is adapted to simultaneously display real time and historic patient data corresponding to a plurality of patients, wherein the real time and historic patient data for each of said plurality of patients is displayed within patient display zones, each of said display zones having a size associated therewith, and wherein the touch screen display comprises at least one icon which, when actuated for a first patient display zone associated with a first patient, causes the system to automatically display data corresponding to data that was displayed for the first patient within a first predefined period before the patient's most recent significant physiological event, during the patient's most recent significant physiological event, and within a second predefined period after the patient's most recent significant physiological event.

In one embodiment, when data from a new patient is acquired by the monitoring system, said sizes of the patient display zones automatically decrease by an amount sufficient to display the data from the new patient, provided that decreasing the sizes of said patient display zones does not result in any one patient display zone having a size less than a predefined number of pixels. In one embodiment, the predefined number of pixels is in a range of 50 to 80 pixels.

In one embodiment, the first predefined period and second predefined period are each four minutes or less.

In one embodiment, the significant physiological event includes an abnormal reading of the patient's SpO₂ level, ECG, invasive blood pressure, heart rate, non-invasive blood pressure, EEG, body temperature, cardiac output, CO₂ level, or respiration rates.

In one embodiment, a patient display zone is automatically removed from said display when a patient bed associated with said patient display zone is not in use. In one embodiment, the sizes of patient display zones remaining after said patient display zone is removed automatically increase.

In one embodiment, the touch screen display is adapted to display an alarm watch zone for displaying alarm statuses corresponding to a set of predefined patients, wherein, when one of the predefined patients has a predefined alarm status, a display of physiological data for the other predefined patients is suppressed.

The aforementioned and other embodiments of the present invention shall be described in greater depth in the drawings and detailed description provided below.

### BRIEF DESCRIPTION OF THE DRAWINGS

These and other features and advantages of the present invention will be further appreciated, as they become better understood by reference to the detailed description when considered in connection with the accompanying drawings:

FIG. 1 is an exemplary user interface of one embodiment of the central monitoring station depicting a number of patients and their associated vital statistics;

FIG. 2 is an exemplary user interface of one embodiment of the central monitoring station functioning as a workstation;

FIG. 3 is an exemplary user interface of one embodiment of a non-dedicated display of the central monitoring station functioning as a workstation;

FIG. 4 is an exemplary user interface of one embodiment of the central monitoring station depicting the alarm watch zone at the bottom of the screen;

FIG. 5 is an exemplary user interface of one embodiment of the central monitoring station depicting the alarm bar and persistent alarm messages;

FIG. 6 is an exemplary user interface of one embodiment of the central monitoring station depicting the ICS alarm view;

FIG. 6A is an exemplary user interface of one embodiment of the central monitoring station depicting a ‘Replay’ of an event selected from an alarm history event, in accordance with an embodiment of the present invention;

FIG. 7 is an exemplary user interface of one embodiment of the central monitoring station with a pop-up window depicting the parameter settings screen of the quick navigation function;

FIG. 8 is an exemplary user interface of one embodiment of the quick navigation parameter settings window of the central monitoring station, depicting the tab for alarm threshold settings for heart rate as measured by ECG;

FIG. 9 is an exemplary user interface of one embodiment of the quick navigation parameter settings window of the central monitoring station, depicting the tab for waveform view settings for the II lead of the 1^{st} Lead ECG;

FIG. 10 is an exemplary user interface of one embodiment of the quick navigation parameter settings window of the central monitoring station, depicting the tab for waveform view settings for arterial pressure;

FIG. 11 is an exemplary user interface of one embodiment of the central monitoring station depicting the icon for an electronic sticky note;

FIG. 12 is an exemplary user interface of one embodiment of the electronic sticky note window of the central monitoring station;

FIG. 13 is an exemplary user interface of one embodiment of the central monitoring station depicting the cardiac view window;

FIG. 13A illustrates a global ischemic index showing an ischemic episode, in accordance with an embodiment of the present invention;

FIG. 14 is a block diagram depicting an exemplary configuration of the displays of the central monitoring station in relation to patient beds, in accordance with a preferred embodiment of the present specification; and,

FIG. 15 is a diagram depicting an exemplary configuration of the central monitoring station in accordance with one embodiment of the present specification.

### DETAILED DESCRIPTION

The present specification is directed toward a dynamic central monitoring station that includes multiple touch screens in which the information displayed is user-configurable. The central monitoring station interfaces with bedside monitors and telemetry devices. The central monitoring station provides for the numerical and graphical presentation of real time patient vital statistics on no less than two and up to four display screens. Real time information for up to 48 patients can be displayed on the central monitoring station.

The central monitoring station described in the present specification also enables the user to access settings menus and view historical patient information. Physiological data monitored and collected includes pulse oximetry (SpO₂), electrocardiograph (ECG), invasive blood pressure (IBP), heart rate, non-invasive blood pressure (NIBP), electroencephalograph (EEG), body temperature, cardiac output, capnography (CO₂), and respiration rates.

A dedicated display screen acts as a workstation and allows personnel to view additional individual patient data, open settings menus, and gain quick access to the Intesys Client Suite (ICS) in which caregivers are able to view retrospective patient data. The dedicated display screen enhances the user interface while allowing for the continuous presentation of vital statistics for all patients on the remaining display(s). The dedicated display screen provides for the integration of real time and historic information. In one embodiment, up to 24 hours of data from within a 72 hour period can be viewed at one time.

Further, the user can remove a patient zone from the display screens if the bed representing the zone is not in use, resulting in an increase in the areas of the remaining zones. This increased area can be used for the display of additional patient data. Once the removed zone becomes used again, the user can restore the previous settings.

The central monitoring station described in the present specification also includes an alarm watch zone. The alarm watch zone is a portion of the display screen that is reserved for less critical patients for whom continuous vital signs are not being displayed at the central monitoring station. Rather, these patients do not appear on the central monitoring station display screens until and unless an alarm situation arises, at which time a visual alarm appears on the screen and an audible alarm is sounded. This feature is user configurable and allows more screen space for the observation of more critical patients.

In addition to traditional alarm notification, each patient under observation via the display screens of the central monitoring station has an alarm bar associated with his or her readout. The alarm bar is a color coded graphical representation of alarm history for each patient, informing the caregiver of the frequency, duration, and type of alarm conditions experienced by each patient over a predetermined period of time. Pressing the alarm bar allows the caregiver to navigate to the ICS alarm view where he can view each individual alarm occurrence. In addition to the alarm bar, persistent alarm messages are presented proximate the patients' waveforms on the display screens. The alarm messages inform the caregiver of the specific alarm condition encountered by the patient and remain on the display screen until acknowledged by the caregiver.

The central monitoring station also includes a quick navigation function to allow users easy access to system settings menus. The caregiver can press any physiological parameter icon to bring up a consistent parameter submenu window. From this window, the caregiver can press a tab for a specific parameter and then change value settings for that parameter. Included in the quick navigation window is a graphical representation of parameter values over a predetermined period of time. This historical information assists the caregiver in setting maximum and minimum threshold values for alarm notification. Also included, when applicable, is a waveform preview sub-window to provide the caregiver with an image of how the parameter waveform will appear before accepting changes.

Optionally, in one embodiment, the central monitoring station described in the present specification provides a ‘Replay’ function that allows clinicians to review the dynamic data presentation as was seen on a bedside display just before a physiological change (pre-event), during the physiological change (the ‘event’), and after the patient has stabilized (post-event). Hence, the Replay function provides a tool to retrospectively evaluate the reasons for clinical deterioration and serves as a quality mechanism to prevent similar instability for the corresponding patient and potentially other patients.

Optionally, in one embodiment, the central monitoring station includes electronic sticky notes that can be used to make notes regarding any user desired information for each patient. When an electronic sticky note has been entered, a small icon of a sticky note is presented proximate the patient name on the display screens. Pressing the sticky note icon brings up a note window in which the caregiver can enter, view, or edit notes.

Optionally, in one embodiment, the central monitoring station includes a cardiac display that provides a cardiac view with specialized data presentation and enables users to quickly visualize pacemaker performance. The cardiac display also provides a presentation of ST values from specified lead combinations and an updated algorithm for telemetry. The cardiac display also provides a single trend as an overall indicator which is used to alert a user to episodes of cardiac ischemia.

The system of the present invention is coupled to at least one display, which displays information about the patient parameters and the functioning of the system, by means of a GUI. The GUI also presents various menus that allow users to configure settings according to their requirements. The system further comprises at least one processor (not shown) to control the operation of the entire system and its components. It should further be appreciated that the at least one processor is capable of processing programmatic instructions, has a memory capable of storing programmatic instructions, and employs software comprised of a plurality of programmatic instructions for performing the processes described herein. In one embodiment, the at least one processor is a computing device capable of receiving, executing, and transmitting a plurality of programmatic instructions stored on a volatile or non-volatile computer readable medium.

The present specification discloses multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

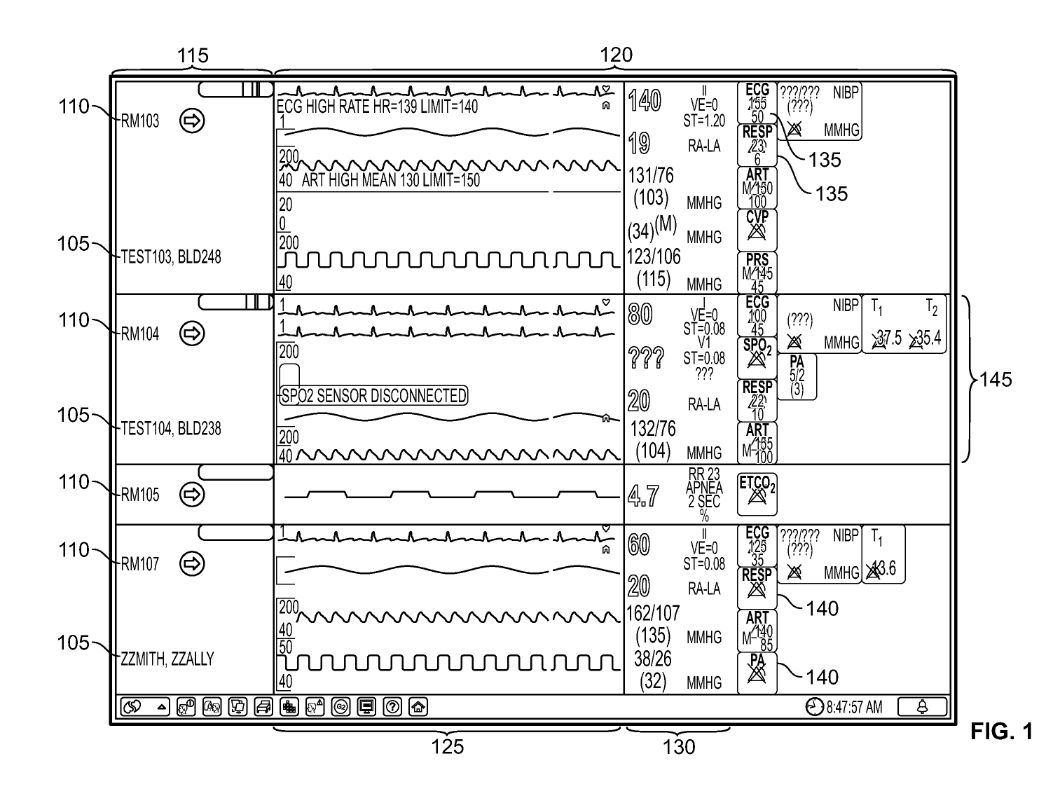

FIG. 1 is a screen shot of one embodiment of a display screen of the central monitoring station depicting a number of patients and their associated vital statistics. The patient name 105 and room number 110 are positioned on the left of the display screen, in a reserved patient information area 115. The patients' vital statistics, including both graphical waveform representations 125 and numerical values 130, occupy the remainder of the screen area 120 to the right. Icons 135 with abbreviations for the various measured physiological parameters are also located in this screen area 120. Optionally, in one embodiment, an icon with a red X through it 140 notifies the caregiver that the represented parameter is not currently being monitored for alarm notification.

Although information for only 4 patients is depicted in FIG. 1, the central monitoring station of the present invention has the capability, in one embodiment, to display vital signs for up to 48 patients. In one embodiment, a patient zone 145 can be removed from the display screen if the corresponding patient bed is not in use. The remaining patient zones will then increase in size to fill the entire screen, allowing for the display of more data for each patient. Conversely, as more patients are admitted to the unit, additional patient zones can be added to the display, in which case the individual zones will become progressively smaller. In one embodiment, a plurality of patient zones are automatically added and displayed in each of a plurality of central monitoring stations whenever a new patient is added to the service, thereby causing the remaining patient zones to decrease in display area size until a predefined pixel threshold within a range of 50-80 pixels, and preferably 62 pixels. In one embodiment, such a decrease is effectuated by decreasing character, font, graph, or icon size while substantially maintaining all of the displayed information. In another embodiment, such a decrease is effectuated by eliminating certain information, such as graphs or physiological data, while substantially maintaining character, font, graph, or icon size. In another embodiment, such a decrease is effectuated by eliminating certain information, such as graphs or physiological data, while partially maintaining character, font, graph, or icon size. In one embodiment, when a new patient occupies a previously empty bed, the system will autosense a live being and the central monitoring station will auto-populate a patient zone on the display screen. A caregiver can then admit the patient from the central monitoring station.

In addition, in one embodiment, the central monitoring station of the present invention allows for dynamic configuring of the display dependent upon patient acuity. Patient acuity is determined by the system examining a number of parameters which can be predetermined or user configured with differing rules on a case by case basis. For example, in one embodiment, a set of rules can be established such that more critical patients are positioned at the top of the display while less critical patients are positioned toward the bottom and non-critical patients have their zones removed entirely. This allows for clustering of patients with similar status and enables the caregivers to function more efficiently. In addition, in one embodiment, the user can adjust the settings displayed so that a more critical patient will have more measured parameters displayed than a less critical patient.

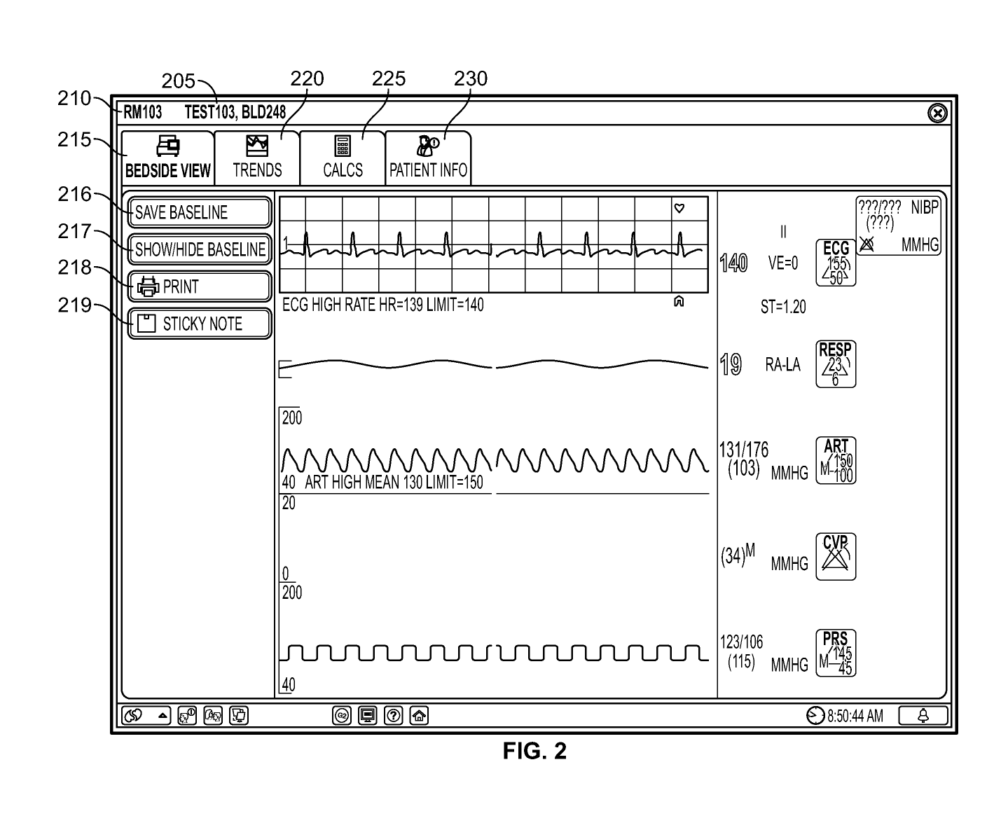

FIG. 2 is a graphical user interface of one embodiment of the central monitoring station functioning as a workstation. In this display, the entire screen of the dedicated display is filled with information for only one patient. As the caregiver focuses on this one patient on the dedicated display, the remaining displays continue to present real time vital statistics for all the patients. Having a dedicated display allows the caregiver to work on one patient while not sacrificing any screen space needed for continuous monitoring of the other patients. The dedicated display functions as a separate workstation that provides the user with quick access to view retrospective data from the ICS.

Referring to FIG. 2, the patient name 205 and room number 210 are presented at the top left corner of the dedicated display screen. Under this information, in one embodiment, are four tabs that include Bedside View 215, Trends 220, Calcs 225, and Patient Info 230. Pressing one of these tabs provides the caregiver historical information and further options related to the patient's vitals. For example, in one embodiment, the Bedside View tab 215 provides additional buttons that allow the user to save a baseline 216, show/hide baseline 217, print 218, and bring up an electronic sticky note 219.

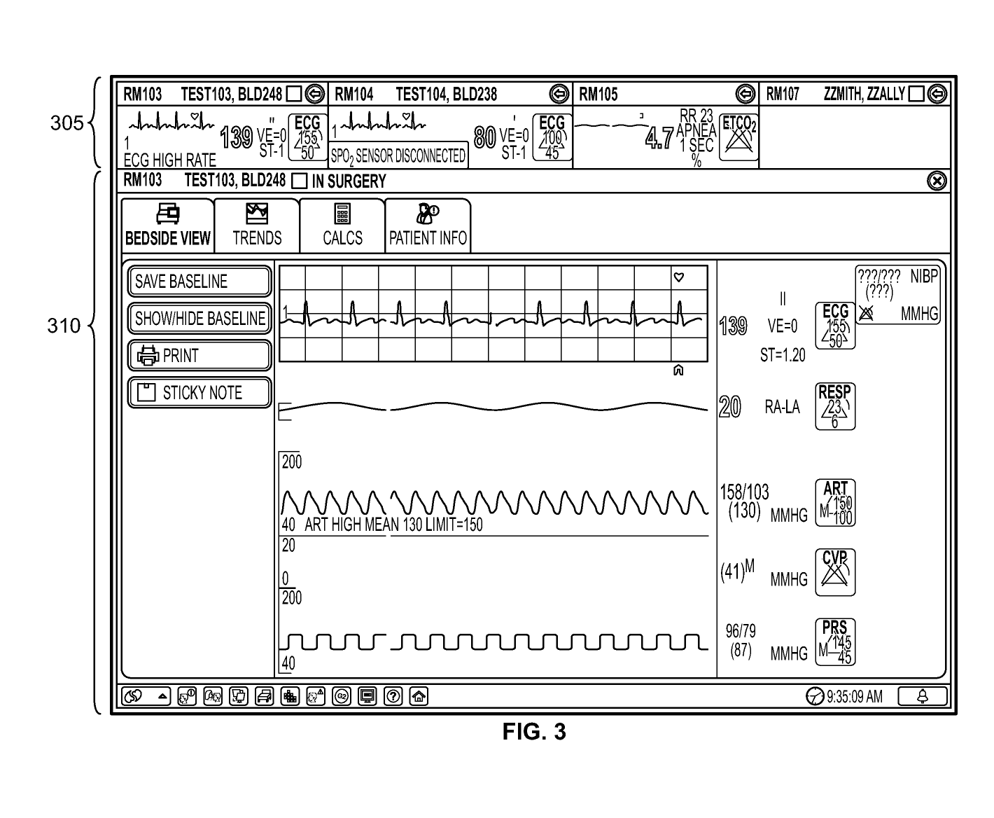

FIG. 3 is a graphical user interface of one embodiment of a non-dedicated display of the central monitoring station functioning as a workstation. The presentation of the display screen is identical to that of the dedicated display in FIG. 2 with the exception that vitals information for the remainder of the patients originally displayed on the non-dedicated display screen has been compacted and positioned at the top of the screen 305. The remaining bottom portion of the non-dedicated display screen 310 is now being used as a workstation and is focused on one patient. Though the information for the other patients has been displayed in a smaller screen area, it is still viewable by the caregiver. Therefore, a caregiver can use a non-dedicated display as a workstation without losing visibility on the remaining patients. A non-dedicated display can be used as a workstation whenever a dedicated display is unavailable, for example, when a dedicated display is not present at the central monitoring station or when the dedicated display is in use by another caregiver.

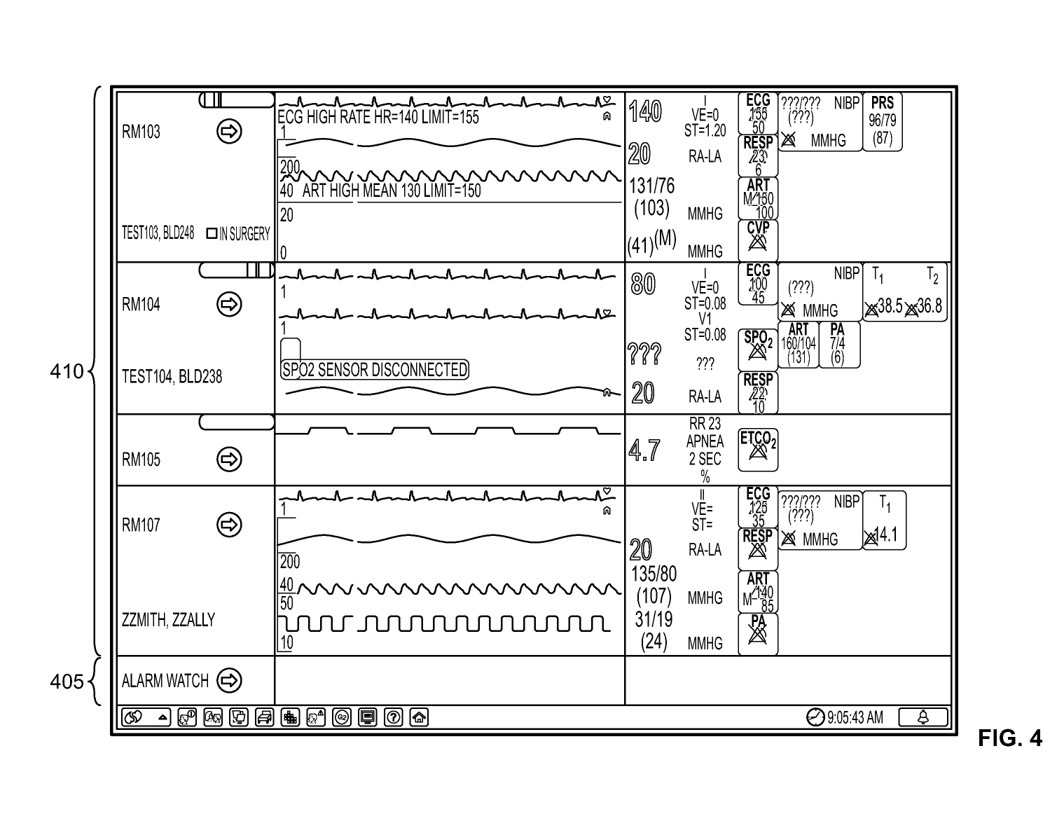

FIG. 4 is a graphical user interface of one embodiment of a display screen of the central monitoring station depicting the alarm watch zone 405 at the bottom of the screen. A number of patient zones occupy the remaining top portion of the screen 410. The alarm watch zone 405 is an area that is reserved for caregiver notification of alarm conditions for patients who are being monitored at the bedside but do not have a patient zone on one of the display screens of the central monitoring station. Typically, these are less critical patients for whom continuous vitals monitoring is unnecessary. The alarm watch zone 405 provides a means of notifying caregivers of alarm conditions for these patients without having to rely on the alarm notification present at the bedside. A caregiver can remain at the central monitoring station to observe the condition of the more critical patients and be sure that he will be notified should a less critical patient enter an alarm state. In one embodiment, the alarm watch zone can display alarm states for up to 8 patients. In one embodiment, an alarm message appears in the alarm watch zone during an alarm state. In one embodiment, the color of the text of the alarm message signifies the severity of the alarm state. For example, red text signifies a severe alarm state, yellow text a moderate alarm state, and blue text a device disconnection or malfunction. In one embodiment, the alarm message flashes. In one embodiment, an audible alarm is produced at the central monitoring station in addition to the alarm message.

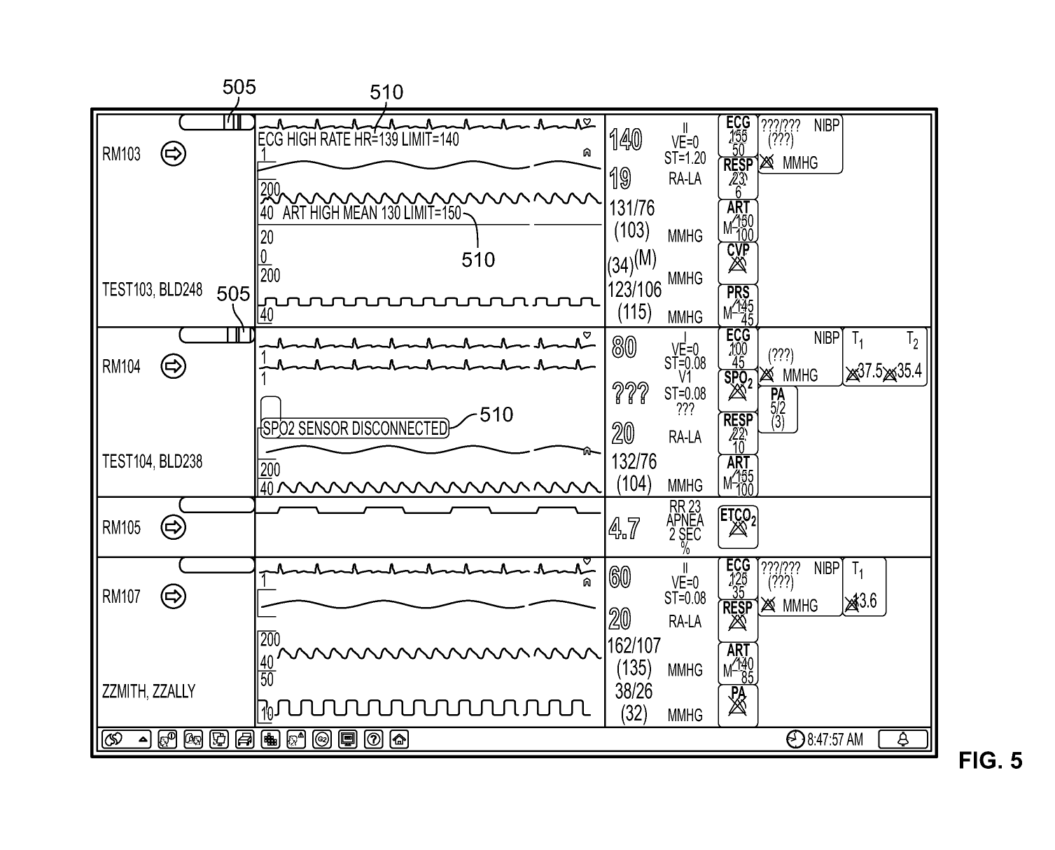

FIG. 5 is a graphical user interface of one embodiment of a display screen of the central monitoring station depicting the alarm bar 505 and persistent alarm messages 510. In one embodiment, the alarm bar 505 is positioned in the top right corner of the patient information area. The alarm bar 505 informs the caregiver of the alarm state of the patient over a user-defined predetermined period of time. In one embodiment, the alarm bar signifies alarm state of the patient over the last 30 minutes. The color of the bar signifies alarm severity and the length of each colored segment within the bar signifies duration of the alarm. In one embodiment, red in the alarm bar signifies a severe alarm state, yellow signifies a moderate alarm state, and blue signifies device disconnection or malfunction. In one embodiment, for example, a wide segment of yellow on the alarm bar notifies the caregiver that the patient was in a moderate alarm state for several minutes.

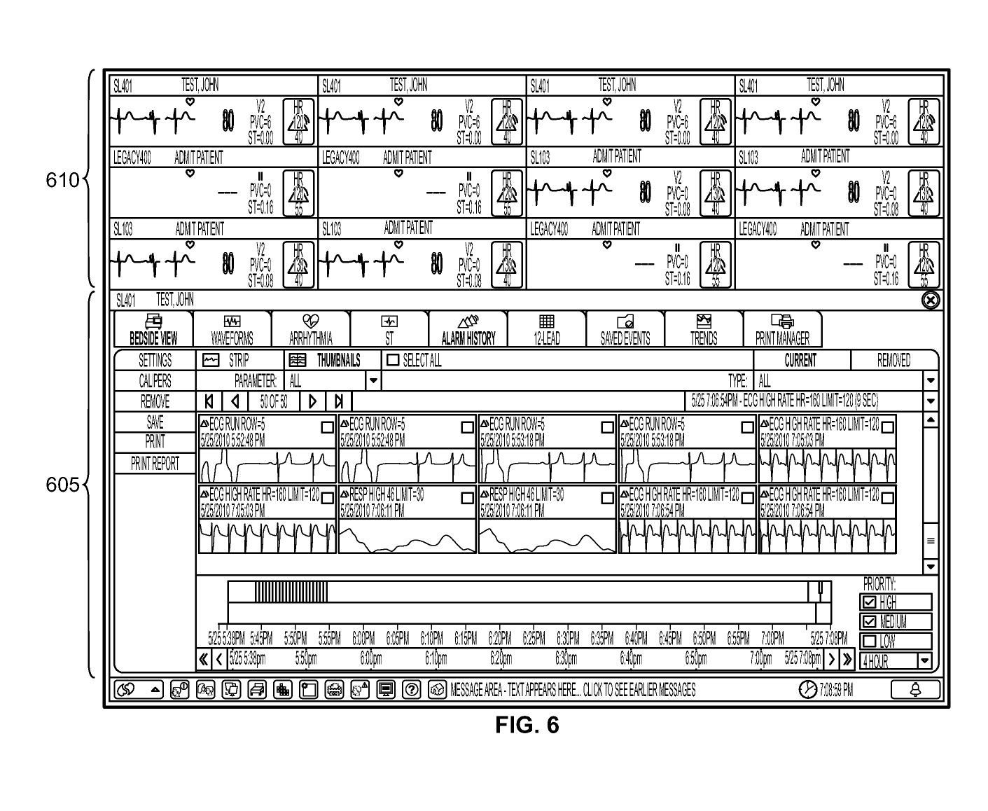

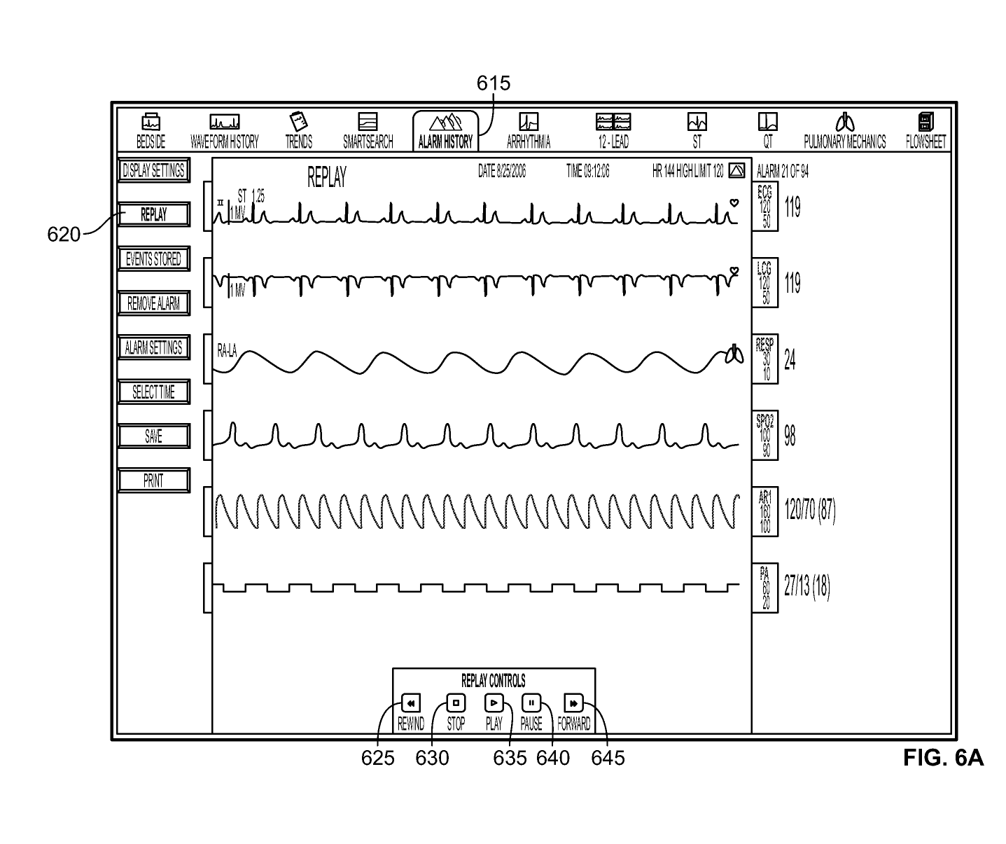

Pressing the alarm bar for a patient navigates the user to the ICS alarm view. FIG. 6 is a screen shot of one embodiment of a display screen of the central monitoring station depicting the ICS alarm view. In this embodiment, the ICS alarm view 605 occupies the lower two thirds of the display while the upper one third is filled with patient zones 610. The ICS alarm view provides the caregiver with historical data regarding the alarm states experienced by a specific patient. Based upon this data, the caregiver can selectively tailor therapy or change the alarm threshold limits.

As is commonly known, patients in critical care environments often have precipitous changes in physiology. In such cases, sometimes the moving waveforms and numeric data presented on a display screen of the central monitoring station may be missed by a clinician. However, at the time of deleterious vital sign changes, the clinician is required to immediately respond to the patient's abnormal physiology. The present invention provides a ‘Replay’ function that allows clinicians to review the dynamic data presentation as was seen on a bedside display just before a physiological change (pre-event), during the physiological change (the ‘event’), and after the patient has stabilized (post-event). Hence, the Replay function provides a tool to retrospectively evaluate the reasons for clinical deterioration and serves as a quality mechanism to prevent similar instability for the corresponding patient and potentially other patients. Further, the Replay function may be used by clinicians in any intensive care unit, emergency department, or operating room to evaluate the sequence of clinical events which lead to an unstable clinical condition. The Replay function may serve as a communication tool between nurse and physician and other health care workers and may also be used in the training of staff.

FIG. 6A is a screen shot of one embodiment of a display screen of the central monitoring station depicting a ‘Replay’ of an event selected from an alarm history 615 event, in accordance with an embodiment of the present invention. Clicking on a Replay control 620 causes a replay of the dynamic data presentation as was seen on a real-time bedside display including the pre-event, event, and post-event data. A set of Replay controls namely rewind 625, stop 630, play 635, pause 640, and forward 645 are provided for rewinding, stopping, playing, pausing or forwarding respectively, the replayed display of events. In an embodiment, a user may select an event such as an alarm or a manually marked clinician event for Replay.

Referring again to FIG. 5, the display screen of the central monitoring station also notifies the caregiver of the last alarm type via an alarm message 510 presented proximate the patient's waveforms. In one embodiment, the alarm message text 510 is color coded to signify the severity of the alarm. In one embodiment, the alarm message text 510 is white and is highlighted with a specific color to represent alarm severity. For example, in one embodiment, red indicates a severe alarm state, yellow indicates a moderate alarm state, and blue indicates device connection or malfunction. The alarm message is persistent and will remain on the display screen until acknowledged by a caregiver. In one embodiment, the caregiver can acknowledge the alarm message by pressing it.

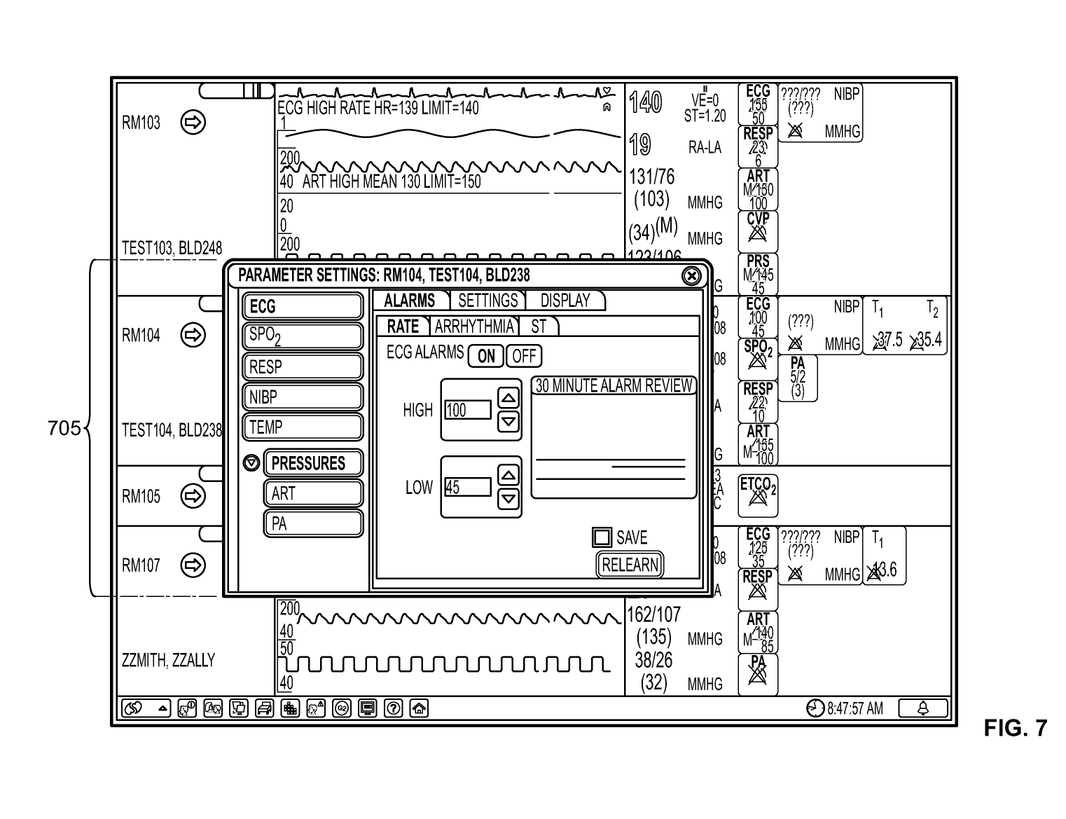

The central monitoring station includes a quick navigation function to allow users easy access to system settings menus. FIG. 7 is a graphical user interface of one embodiment of a display screen of the central monitoring station with a pop-up window 705 depicting the parameter settings screen of the quick navigation function. When a caregiver presses any parameter icon, the quick navigation function brings up the settings menu that contains buttons for all measured parameters for that patient. By pressing a parameter button, the caregiver can change settings for that particular parameter. For example, in one embodiment, a caregiver can choose to change settings for ECG, SpO₂, RESP, NIBP, TEMP, and, ART and PA pressures from the same settings menu by pressing the appropriate parameter button. This enables the caregiver to adjust settings for all the parameters from one consistent view without having to exit and re-enter separate settings menus, thereby increasing caregiver efficiency.

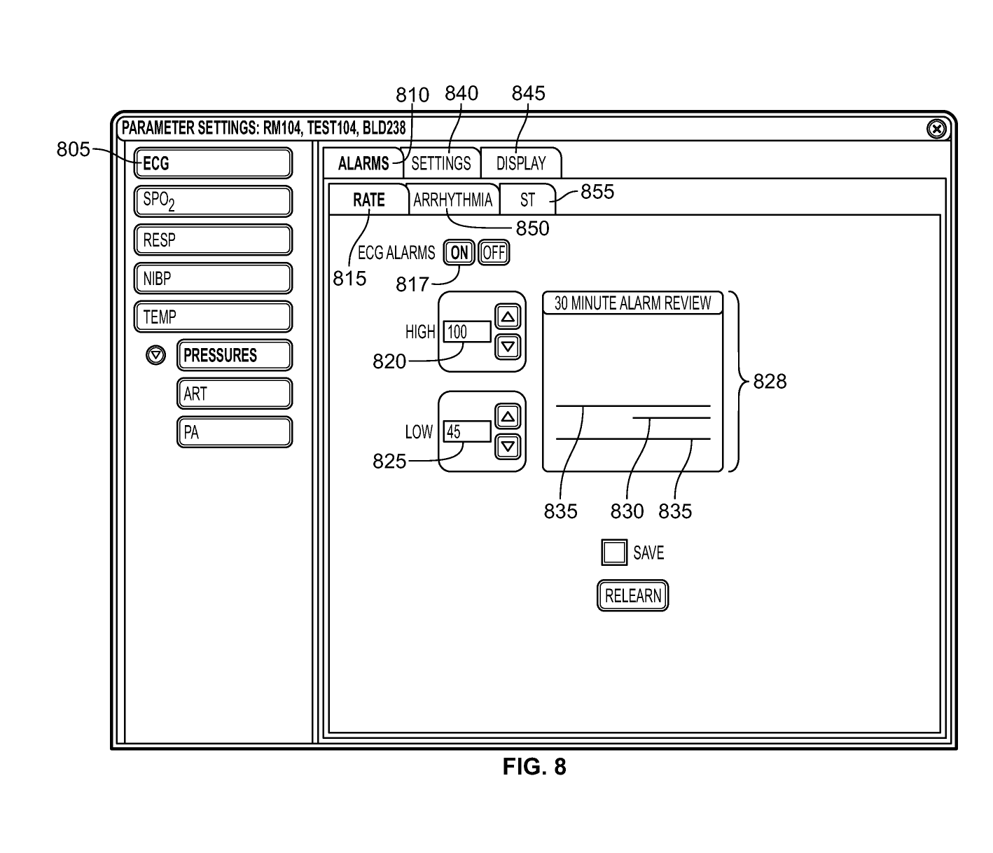

FIG. 8 is a graphical user interface of one embodiment of the quick navigation parameter settings window of the central monitoring station, depicting the tab 810 for alarm threshold settings for heart rate as measured by ECG. In this example, the button for ECG 805 is outlined in blue and tabs for Alarms 810 and Rate 815 are highlighted blue to notify the caregiver that he is accessing the settings for the ECG heart rate alarms. The ECG Alarms button for On 817 is also highlighted blue, signifying that the ECG heart rate alarms are switched on. The caregiver can adjust the maximum and minimum threshold values for the ECG heart rate alarms by pressing the up and down arrows for the high 820 and low 825 heart rate alarm threshold settings. In addition, a graph 828 representing alarm values over a predetermined period of time is displayed in the settings menu. The graph 828 also includes two solid lines depicting the preset maximum and minimum threshold values in relation to the measured value. By viewing this graph, a caregiver can determine how often the measured value fell outside the preset thresholds over a specific time period and tailor treatment or change threshold values accordingly. In one embodiment, the measured heart rate is displayed as a green line 830 and the maximum and minimum threshold values are displayed as white lines 835. In one embodiment, the review time is set to 30 minutes.

In one embodiment, from the ECG settings menu, the caregiver can also access additional ECG settings other than Alarms by pressing the Settings tab 840 or the Display tab 845. As can be seen in FIG. 8, the caregiver can also access other alarm settings besides Rate alarms by pressing the Arrhythmia tab 850 and the ST tab 855 within the ECG Alarms submenu.

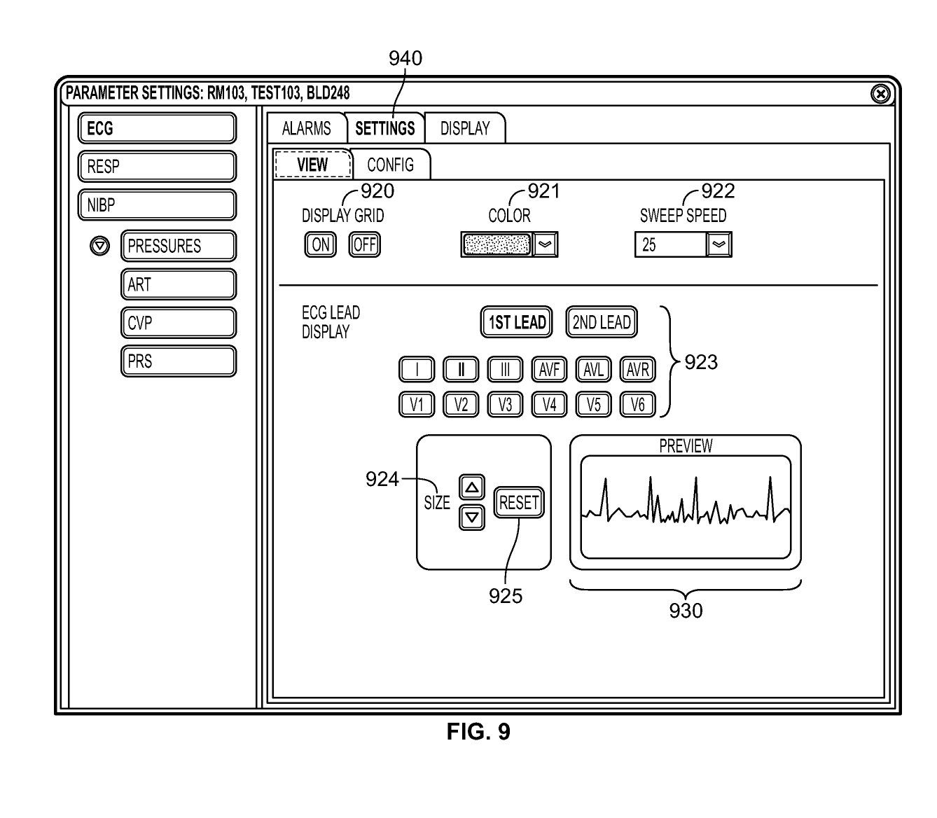

FIG. 9 is a graphical user interface of one embodiment of the quick navigation parameter settings window of the central monitoring station, depicting the tab 940 for waveform view settings for the II lead of the 1^{st} Lead ECG. A multitude of settings, including grid display 920, waveform color 921, sweep speed 922, lead selection 923, and size 924 can be changed from this settings submenu. A reset button 925 is also included. In one embodiment, the waveform settings submenu includes a preview 930 of the waveform as it will appear based upon the changes made. With the preview 930, the caregiver can view the waveform appearance before accepting the changes and has the opportunity to make further changes or reset if desired. Other ECG settings can be changed via additional tabs as described above.

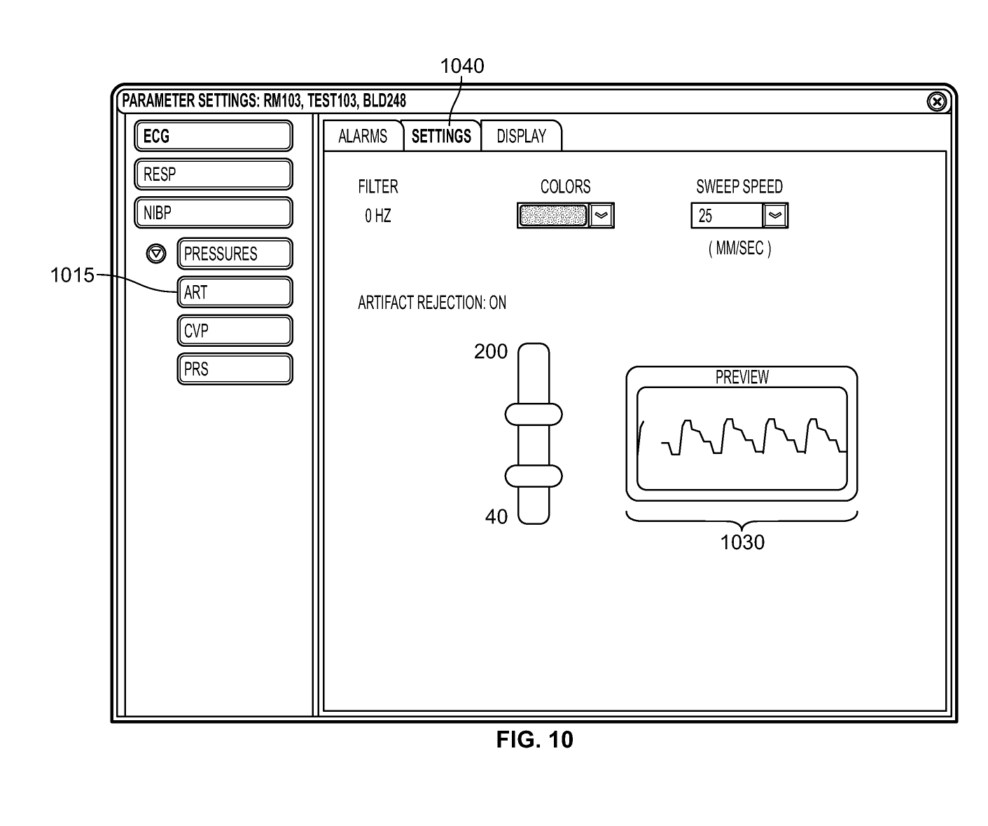

FIG. 10 is a screen shot of one embodiment of the quick navigation parameter settings window of the central monitoring station, depicting the tab 1040 for waveform view settings for arterial pressure. The button for ART pressure 1015 is outlined in blue to notify the user he is accessing the settings submenu for arterial pressure. Again, the user can adjust a number of settings and is presented with a preview 1030 to view before accepting changes.

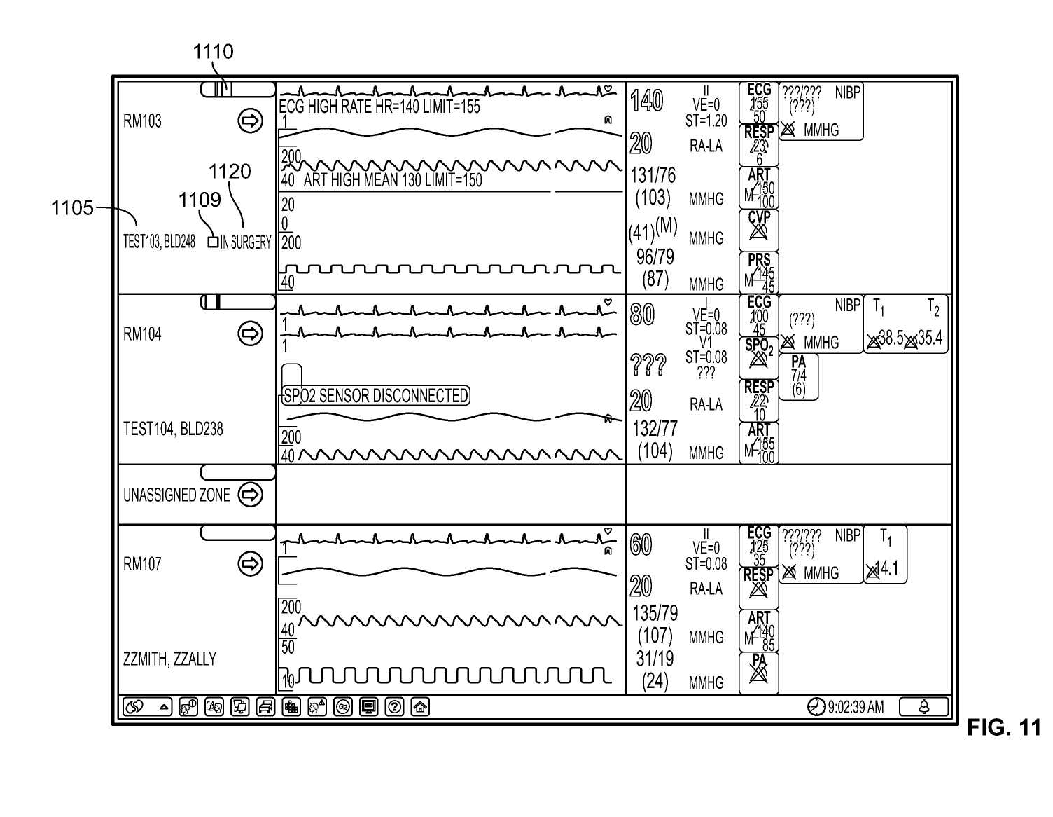

FIG. 11 is a graphical user interface of one embodiment of a display screen of the central monitoring station depicting the icon 1109 for an electronic sticky note. In one embodiment, the icon 1109 is positioned within the patient information area, below the alarm bar 1110 and to the right of the patient name 1105. In one embodiment, a short text message 1120 is displayed immediately to the right of the electronic sticky note icon 1105, still within the patient information area. The text message 1120 represents the title of the first note within the electronic sticky note. The electronic sticky note is used by caregivers to write quick notes regarding the patient's care or condition and replace traditional paper sticky notes which can become dislodged and lost easily, thereby forming a more permanent record and eliminating clutter.

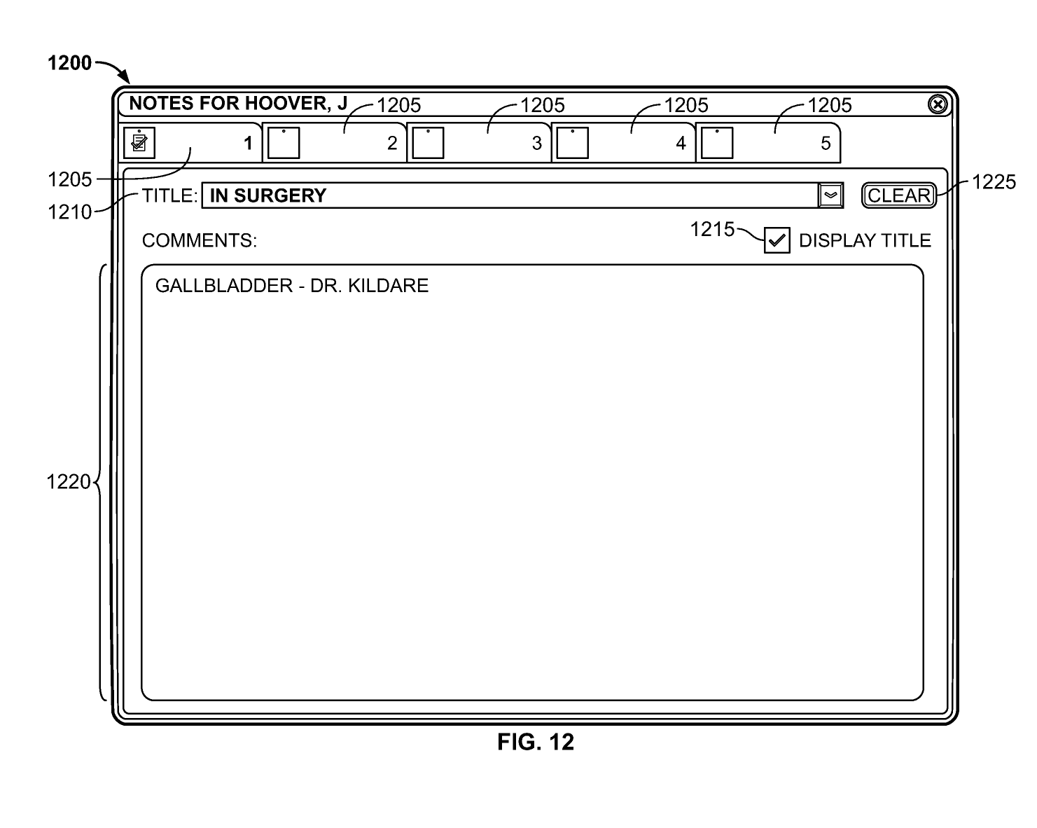

FIG. 12 is a graphical user interface of one embodiment of the electronic sticky note window 1200 of the central monitoring station. In one embodiment, up to 5 notes can be written per electronic sticky note, as notated by the 5 tabs 1205 depicted in FIG. 12. In one embodiment, each note includes a title 1210 that can be entered or chosen from a drop down menu. Each note also includes a box 1215 that can be checked so that the title will be displayed on the display screen as a short text message to the right of the electronic sticky note icon, as depicted in FIG. 11. In addition, each note includes a comments section 1220 that can be filled out and a clear button 1225.

As is known in the art, measurement of an ST segment of the ECG is a standard technique for detection of cardiac ischemia. A trained clinician can ascertain the level of change in various ECG leads indicating which region of the heart is being deprived of oxygenated blood. Many patients may have “silent ischemia”, in which the patient feels no discomfort despite minor transient ischemic attacks which are common precursors to a potentially fatal myocardial infarction. Hence, continuous monitoring of ST segment levels is common practice in many hospital care areas. However, viewing ST segment level changes (from baseline) in multiple leads may be confusing to an inexperienced user. Also, a typical patient monitor may have limited screen space in which to display all available (up to 12) leads of ST data. The present disclosure provides a single trend as an overall indicator which is used to alert a user to episodes of cardiac ischemia.

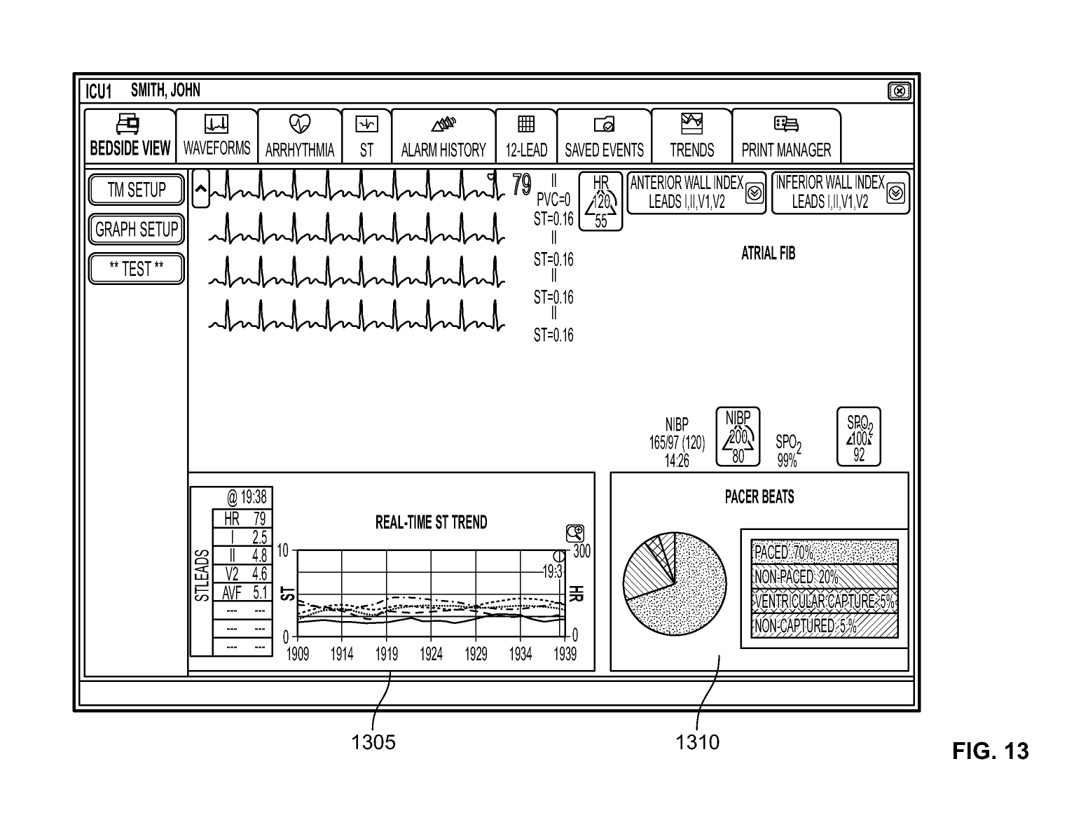

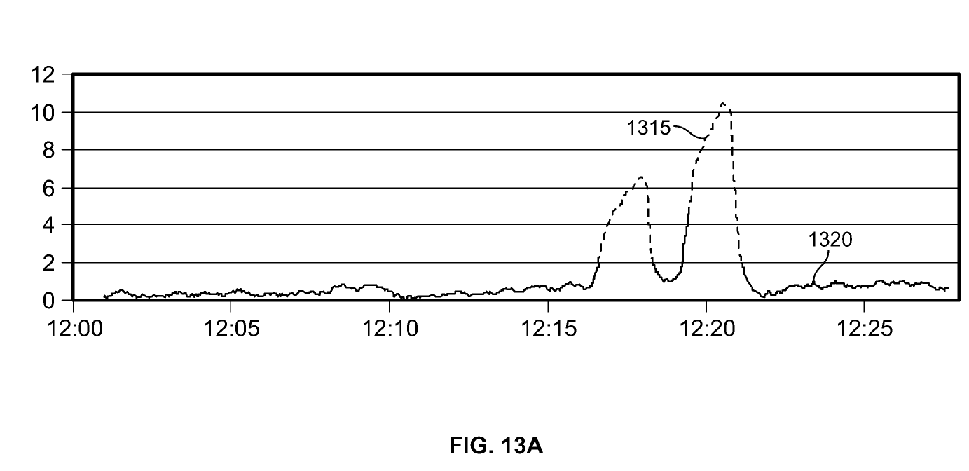

FIG. 13 is a graphical user interface of one embodiment of a display screen of the central monitoring station depicting the cardiac view window. The cardiac view provides a specialized data presentation with which the caregiver can quickly visualize pacemaker performance. In one embodiment, the cardiac view window provides an ST Index which includes a presentation of ST values from specified lead combinations. The ST Index is a summation of ST values measured each second and can be predefined or set by the user. The ST values are measured as part of a specialized ST software package. Measured values are displayed graphically and alarm thresholds can be set by the user. The ST Index can also be used to quantify areas of the heart that are damaged. A real time ST trend graph 1305 and a pacer beats pie chart 1310 are depicted in FIG. 13.

In an embodiment, the ST segment levels for the 3 most orthogonal leads available are combined into a single Global Ischemic Index (GII) by using the following equation:

GII=|ΔX|+|ΔY|+|ΔZ| (EQUATION 1),

where X, Y and Z are three semi-orthogonal ECG leads, and the deltas are deviations from the learned baseline for each lead.

Since the GII incorporates ST segment data from orthogonal leads, ischemia in any portion of the heart will appear in the GII trend. If an ischemic episode is visible in the GII trend, then the clinician can be alerted to the episode and appropriate diagnostic steps can be taken to identify exactly which leads, and by inference which parts of the heart, are showing signs of ischemia. FIG. 13A illustrates a global ischemic index showing an ischemic episode, in accordance with an embodiment of the present invention. The displayed trend of GII level as illustrated in FIG. 13A appears as a red line 1315 during episodes of ischemia and a green line 1320 otherwise.

In one embodiment, the central monitoring station of the present invention also includes an updated algorithm with the cardiac view. The updated algorithm has additional arrhythmia capabilities and expanded ST functions with indexes. New measurement capabilities, including QRS duration, QT and QTc measurement, and prolonged PR intervals are also included. In addition, the updated algorithm provides for rate related detection and notification for atrial fibrillation (Afib), bradycardia, tachycardia, ideoventricular rhythm (IVR), and accelerated ideoventricular rhythm (AIVR).

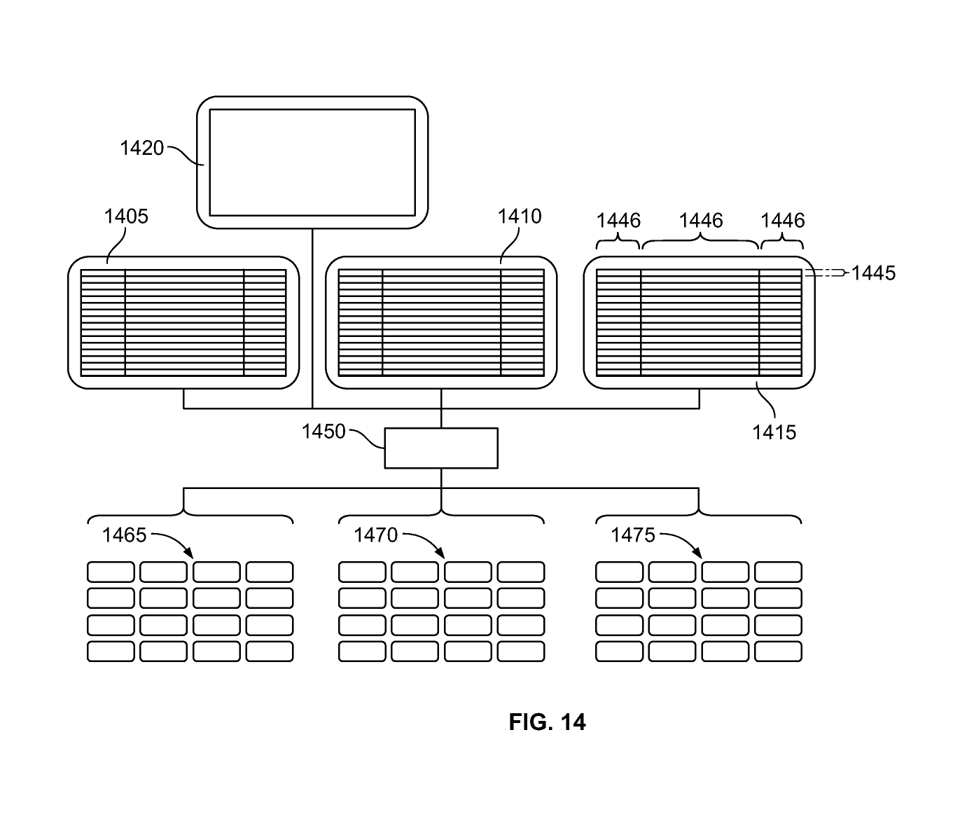

As described above, the central monitoring station of the present specification can include up to four touch screens, wherein three screens are display screens and one screen functions as a dedicated display screen for use by medical personnel to focus on one individual patient. Each of the three display screens is capable of displaying information for up to 16 patients, allowing for the display of information for up to a total of 48 patients at one time. FIG. 14 is a block diagram depicting an exemplary configuration of the displays 1405, 1410, 1415, 1420 of the central monitoring station in relation to patient beds 1465, 1470, 1475, in accordance with a preferred embodiment of the present specification. Each of the display screens 1405, 1410, 1415 displays information from one of the groups 1465, 1470, 1475 of patient beds. Each group 1465, 1470, 1475 of patient beds includes up to 16 beds. For example, display screen 1405 displays information for each of the up to 16 patients represented by the beds in group 1465, screen 1410 displays information for the patients in group 1470, and screen 1415 displays information for the patients in group 1475. Each display screen 1405, 1410, 1415 comprises up to 16 patient zones 1445, wherein each patient zone 1445 displays information relating to the corresponding patient in the appropriate group 1465, 1470, 1475. Further, in one embodiment, each patient zone 1445 is divided into subsections 1446 to display patient name, bed, numerical and graphical values, alarm states, and other pertinent data.

In operation, monitored patient data from each patient in each group 1465, 1470, 1475 is transferred, either wired or wirelessly, to a central computer 1450. The data is processed at the central computer 1450 and then displayed on the appropriate display screen 1405, 1410, 1415. The dedicated display screen 1420 is reserved for accessing and reviewing information for a single patient at a time, allowing the three display screens 1405, 1410, 1415 to provide uninterrupted information for all patients at all times.

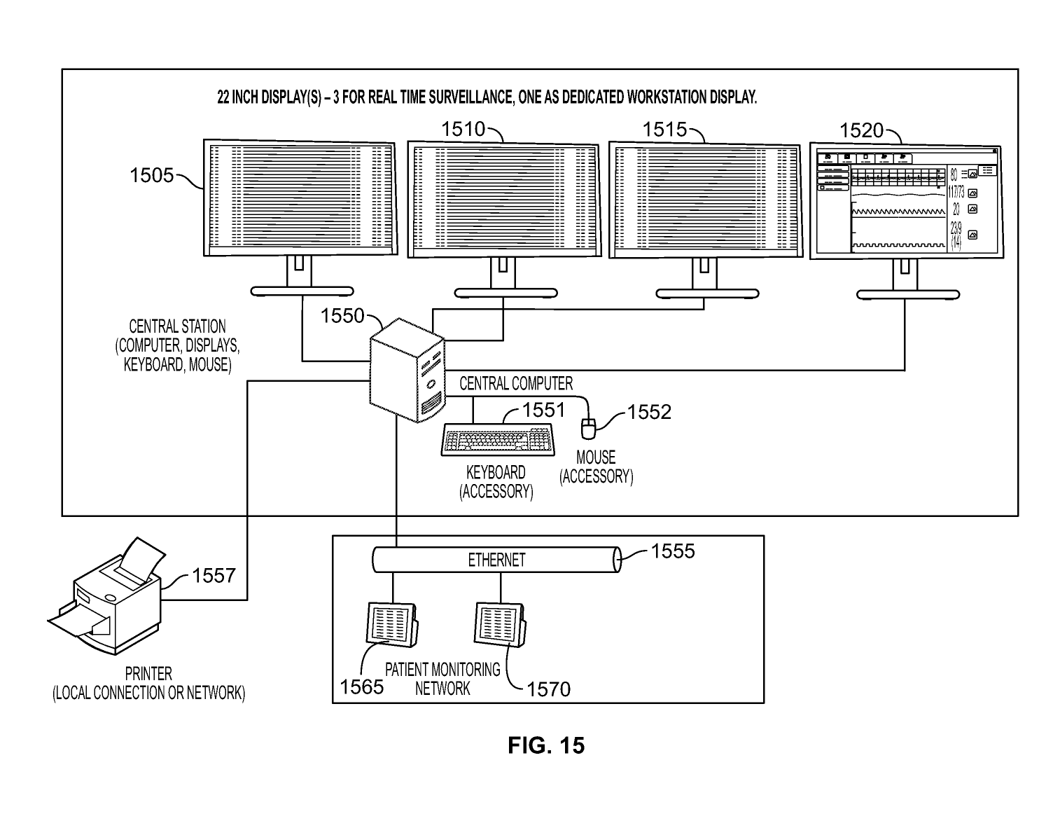

FIG. 15 is a diagram depicting an exemplary configuration of the central monitoring station in accordance with one embodiment of the present specification. In the pictured embodiment, the central monitoring station includes three display screens 1505, 1510, 1515 and one dedicated display screen 1520. All of the screens 1505, 1510, 1515, 1520 are operably connected to and receive information from a central computer 1550. The central computer 1550 processes patient monitoring information received from patient groups 1565, 1570 of a patient monitoring network through a hospital Ethernet 1555. In the pictured embodiment, the central monitoring station additionally includes keyboard 1551 and mouse 1552 accessories for medical personnel to access, review, and manipulate monitored patient data. The central monitoring station also includes a local or network printer 1557 for printing of monitored patient data.

The above examples are merely illustrative of the many applications of the system of the present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A dynamic patient monitoring system comprising:
a central monitoring station coupled with a plurality of monitors to generate monitored physiological data; and
a touch screen display adapted to receive and display numerical and graphical representations of monitored physiological data from a plurality of patients, wherein the touch screen display is adapted to simultaneously display real time and historic patient data corresponding to a plurality of patients, wherein the real time and historic patient data for each of said plurality of patients is displayed within patient display zones, each of said display zones having a size associated therewith, and wherein, when data from a new patient is acquired by the monitoring system, said sizes of the patient display zones automatically decrease by an amount sufficient to display the data from the new patient, provided that decreasing the sizes of said patient display zones does not result in any one patient display zone having a size less than a predefined number of pixels.

2. The dynamic patient monitoring system of claim 1 wherein the sizes of all of said patient display zones are equal.

3. The dynamic patient monitoring system of claim 1 wherein the sizes of all of said patient display zones are not equal.

4. The dynamic patient monitoring system of claim 1 wherein the predefined number of pixels is in a range of 50 to 80 pixels.

5. The dynamic patient monitoring system of claim 1 wherein each of said patient display zones is configurable to display up to 24 hours of patient data from within a 72 hour period at one time.

6. The dynamic patient monitoring system of claim 1, wherein the touch screen display comprises at least one icon which, when actuated for a first patient display zone associated with a first patient, causes the system to automatically display data corresponding to data that was displayed for the first patient within two minutes before the patient's most recent significant physiological event, during the patient's most recent significant physiological event, and within two minutes after the patient's most recent significant physiological event.

7. The dynamic patient monitoring system of claim 6 wherein the significant physiological event includes an abnormal reading of the patient's SpO₂ level, ECG, invasive blood pressure, heart rate, non-invasive blood pressure, EEG, body temperature, cardiac output, CO₂ level, or respiration rates.

8. The dynamic patient monitoring system of claim 1 wherein a patient display zone is automatically removed from said display when a patient bed associated with said patient display zone is not in use.

9. The dynamic patient monitoring system of claim 8 wherein the sizes of patient display zones remaining after said patient display zone is removed automatically increase.

10. The dynamic patient monitoring system of claim 1, wherein the touch screen display is adapted to display an alarm watch zone for displaying alarm statuses corresponding to a set of predefined patients, wherein, when one of the predefined patients has a predefined alarm status, a display of physiological data for the other predefined patients is suppressed.

11. The dynamic patient monitoring system of claim 1, wherein the touch screen patient display is adapted to display at least one electronic note area for recording information corresponding to each patient within the patient's display zone, wherein said at least one electronic note area is actuated by clicking on an electronic note icon positioned proximate a name of the patient.

12. The dynamic patient monitoring system of claim 1 wherein the touch screen patient display is configured to display a representation of ST values from one or more predefined cardiac monitor lead combinations.

13. The dynamic patient monitoring system of claim 1 wherein the touch screen patient display is adapted to display an ischemic index trend representing ST segment levels for three orthogonal leads of a cardiac monitor connected to the patient's heart and wherein the ischemic index trend indicates ischemia in any portion of the heart.

14. A dynamic patient monitoring system comprising:
a central monitoring station coupled with a plurality of monitors to generate monitored physiological data; and
a touch screen display adapted to receive and display numerical and graphical representations of monitored physiological data from a plurality of patients, wherein the touch screen display is adapted to simultaneously display real time and historic patient data corresponding to a plurality of patients, wherein the real time and historic patient data for each of said plurality of patients is displayed within patient display zones, each of said display zones having a size associated therewith, and wherein the touch screen display comprises at least one icon which, when actuated for a first patient display zone associated with a first patient, causes the system to automatically display data corresponding to data that was displayed for the first patient within a first predefined period before the patient's most recent significant physiological event, during the patient's most recent significant physiological event, and within a second predefined period after the patient's most recent significant physiological event.

15. The dynamic patient monitoring system of claim 14 wherein, when data from a new patient is acquired by the monitoring system, said sizes of the patient display zones automatically decrease by an amount sufficient to display the data from the new patient, provided that decreasing the sizes of said patient display zones does not result in any one patient display zone having a size less than a predefined number of pixels.

16. The dynamic patient monitoring system of claim 15 wherein the predefined number of pixels is in a range of 50 to 80 pixels.

17. The dynamic patient monitoring system of claim 14 wherein the first predefined period and second predefined period is four minutes or less.

18. The dynamic patient monitoring system of claim 14 wherein the significant physiological event includes an abnormal reading of the patient's SpO₂ level, ECG, invasive blood pressure, heart rate, non-invasive blood pressure, EEG, body temperature, cardiac output, CO₂ level, or respiration rates.

19. The dynamic patient monitoring system of claim 15 wherein a patient display zone is automatically removed from said display when a patient bed associated with said patient display zone is not in use.

20. The dynamic patient monitoring system of claim 19 wherein the sizes of patient display zones remaining after said patient display zone is removed automatically increase.

21. The dynamic patient monitoring system of claim 14, wherein the touch screen display is adapted to display an alarm watch zone for displaying alarm statuses corresponding to a set of predefined patients, wherein, when one of the predefined patients has a predefined alarm status, a display of physiological data for the other predefined patients is suppressed.
